(19) United States
(12) Patent Application Publication
(10) Pub. No.: US 2006/0227455 A1
(43) Pub. Date: Oct. 12, 2006

(54) Spindle motor with flexible circuit board and disk drive including the same

(75) Inventors: Takehito Tamaoka, Kyoto (JP); Kazuaki Matsuda, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/397,858

(22) Filed: Apr. 5, 2006

(30) Foreign Application Priority Data
Apr. 8, 2005 (JP) 2005-112837

(51) Int. Cl. G11B 17/02

(52) U.S. Cl. 360/99.08

(57) ABSTRACT

A spindle motor for rotating a recording disk such as a magnetic disk is disclosed. The stator coil of the spindle motor is connected to an external device using a FPC including an outer frame located on the upper surface of a circular core back of the stator core and a plurality of connecting portions formed continuously in radial direction inward from the outer frame each with a land connected with a each coil end between adjacent ones of the teeth of the stator core. Each connecting portion is bent down from the outer frame and arranged under the stator. The FPC connecting portions are each arranged between the teeth and bent down axially under the stator. In this way, the FPC connecting portions can be easily held fixedly to reduce the thickness of the motor.

### BACKGROUND OF THE INVENTION

1. Field of the Invention

This invention relates to a spindle motor of inner rotor type for supplying a current to the stator coil using a flexible printed circuit board (FPC) to rotationally drive a recording disk, for example, or in particular to a thin, compact spindle motor suitably used for rotationally driving a recording disk not more than one inch in outer diameter, and a recording disk drive having the spindle motor mounted thereon.

2. Description of the Related Art

A recording disk drive, or especially, a hard disk drive (HDD) mounted for use on a portable music player or a portable device such as a mobile phone is required to be thin and compact. In mounting the HDD on a mobile phone, in particular, the outer diameter of the HDD disk not more than 1 inch is essential, in which case the axial height of the spindle motor built in the HDD is required is several mm. Though difficult to further reduce the thickness greatly, demand has increased for a still smaller size and thickness on micro order.

Generally, in designing a compact and thin spindle motor, the spindle motor of inner rotor type with a rotor magnet arranged on the inner periphery of the stator is employed due to the limited rotor diameter of the spindle motor of outer rotor type which has a rotor magnet on the outer periphery of the stator. In an application of the spindle motor of inner rotor type to HDD, the recording disk is mounted on the rotor in such a manner as to cover the upper surface of the stator. A magnetic shield plate is arranged, therefore, between the stator and the recording disk in order to prevent the leakage magnetic fluxes of the stator and the magnet opposed to the stator from having an adverse effect on the recording disk.

In a small, thin spindle motor of inner rotor type, a flexible printed circuit board (FPC) used to supply the current to the stator coil is arranged on the upper surface of the stator due to the limited inner space of the motor. Specifically, the FPC is arranged between a magnetic shield plate and the stator and prevented by the magnetic shield plate from being raised.

To further reduce the thickness of the spindle motor to 1 inch or less, both the height of the recording disk and the height of the magnetic head for reading or writing data in the recording disk are required to be reduced. In this case, the magnetic shield plate arranged above the stator may be partially removed to such an extent that the recording disk is not affected. Removal of the magnetic shield plate to hold the FPC height, however, would inconveniently make it difficult to successfully fix the FPC, with the result that the motor as a whole cannot be reduced in thickness.

### SUMMARY OF THE INVENTION

The object of this invention is to provide a spindle motor of inner rotor type in which the FPC arranged on the upper surface of the stator can be effectively fixed. A spindle motor reduced in thickness can be thus provided in which FPC is not raised even in the case where at least the magnetic shield plate of the movable part of the magnetic head of HDD is removed.

The spindle motor according to the invention uses the FPC to connect the stator coil to an external device. The FPC is configured of an outer frame located on the upper surface of an annular core back of the stator core and a plurality of connecting portions formed continuously radially inward of the outer frame and arranged in such a manner that the land connected with each coil end is located between adjacent ones of the teeth of the stator core, each connector being bent down from the outer frame and arranged under the stator.

In this configuration, the FPC connecting portions are arranged between the teeth and bent down to be located axially downward of the stator. In this way, the connecting portions which have so far been arranged between the teeth to reduce the thickness as far as possible and therefore difficult to fix can easily fixed and held. As a result, the motor can be reduced in thickness while at the same time fixing the FPC, or especially, the connecting portions. Further, the connecting portions being arranged under the stator are held between the coils and thus can be held under the stator. The FPC, therefore, is kept immovable against vibrations or shocks from outside the motor, and the breakage of the coil lead which otherwise might be caused by the movement of the connecting portions is prevented.

Also, the recording disk drive according to this invention is so configured that a circular recording disk is held on the rotary unit of the spindle motor, and the magnetic head is rendered to access the recording disk by a head moving mechanism.

In a miniature motor not more than 1 inch, the rotary torque is so small that the magnetic force of the rotor magnet can be small. This reduces the magnetic flux leakage between the rotor magnet and the stator opposed thereto. As long as the distance from the upper surface of the stator to the surface on which the recording disk is mounted is not less than 0.2 mm, therefore, the recording disk is not fatally affected. As a result, the magnetic shield plate which has conventionally be required to prevent the leakage of magnetism can be removed.

### BRIEF DESCRIPTION OF THE DRAWINGS

Referring now to the attached drawings which form a part of this original disclosure:

FIG. 1 is a sectional view showing a recording disk drive according to an embodiment of the invention;

FIG. 2 is an enlarged sectional view of a spindle motor according to the invention used in FIG. 1;

FIG. 3 is a plan view showing a state in which the FPC is arranged on the upper surface of the stator used in the spindle motor of FIG. 2;

FIG. 4a is a plan view showing a state in which a shield plate is arranged on the upper surface of the stator shown in FIG. 3;

FIG. 4b is a plan view showing a state in which a shield plate is arranged on the upper surface of the stator shown in FIG. 3 according to another embodiment;

FIG. 5 shows partially enlarged plan views of the stator of FIG. 3 to explain the process of mounting the FPC on the stator, in which (a) to (c) show different steps;

FIGS. 6(a) to 6(c) are diagrams showing the FPC according to other embodiments of the invention; and

FIG. 7 is a plan view of the stator of the spindle motor according to another embodiment of the invention.

### DETAILED DESCRIPTION OF THE PREFERRED EMBODIMENTS

<Recording Disk Drive>

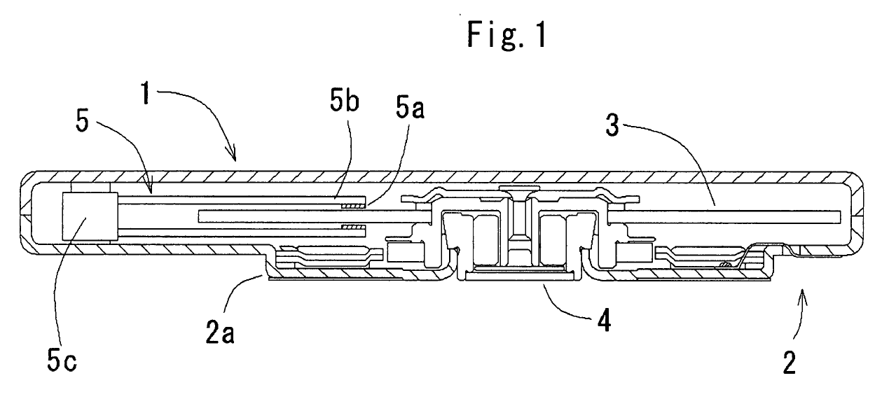

FIG. 1 shows a recording disk drive according to a first embodiment of the invention. A recording disk drive 1 has an outer housing configured of a substantially rectangular thin, flat box-like case 2. The interior of the case 2 forms a clean space substantially free of dust and dirt. The case 2 includes a lower case portion 2a and an upper case portion 2b, and an annular depression is formed on the bottom of the lower case portion 2a. A spindle motor 4 for rotationally driving a circular hard disk 3 making up an information recording medium is arranged in the annular depression. According to this embodiment, the lower case portion 2a of the case makes up a base member of the spindle motor 4. Alternatively, however, a base member independent of the case 2 may be mounted on the case 2.

A head moving mechanism 5 for reading and writing data in the hard disk 3 is arranged in the case 2. This head moving mechanism 5 includes a magnetic head 5a for reading and writing information on the hard disk 3, an arm 5b supporting the magnetic head 5a and an actuator 5c for moving the magnetic head 5a to the desired position on the hard disk 3 by rotating the arm 5b.

By using the spindle motor according to the invention as a spindle motor 4 of the recording disk drive 1 described above, the recording disk drive 1 high in reliability and durability is provided by reducing both the size and thickness while at the same time securing sufficient functions thereof.

<General Structure of Spindle Motor 4>

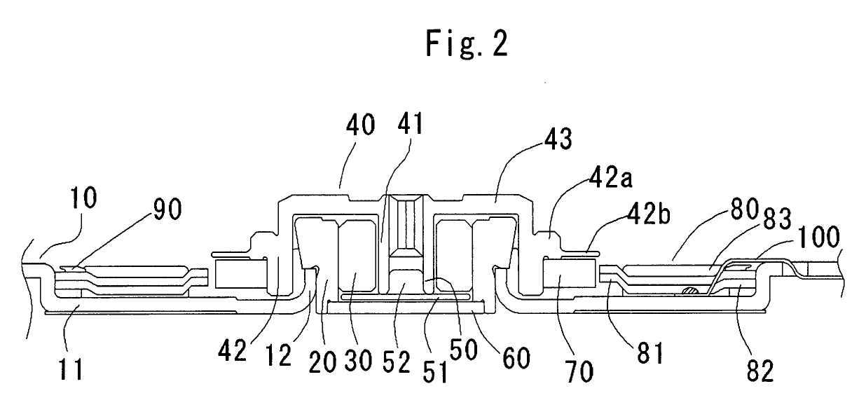

The spindle motor 4 according to an embodiment of the invention is shown in FIG. 2. A base member 10 configured of the lower case portion 2a of the case 2 is molded by plasticization of nonmagnetic stainless steel material in press or the like. The annular depression 11 is also formed at the time of this plasticization. A cylindrical portion 12 directed axially upward is formed at the center of the annular depression 11. A substantially cylindrical bearing housing 20 is fixed on the inner peripheral surface of the cylindrical portion 12. Further, a cylindrical bearing sleeve 30 molded by sintering an oil-contained porous member is fixed on the inner peripheral surface of the housing 20.

A rotor hub 40 includes an axial unit 41, a cylindrical unit 42 on the outer periphery of the axial unit and a cover 43 for connecting the axial unit 41 and the cylindrical unit 42. The axial unit 41 is inserted in the bearing sleeve 30, and the outer peripheral surface of the axial unit 41 and the inner peripheral surface of the bearing sleeve 30 are radially arranged in opposed relation to each other through a minuscule gap. The lower surface of the cover 43 and the upper surface of the housing 20 are axially arranged in opposed relation to each other through a minuscule gap. The axial unit 41 is formed with a through hole at the axial center thereof, and a cap 50 is fitted on the lower end surface of the axial unit 41. The cap 50 includes a disk portion 51 and a protrusion 52 located at the center of the disk portion 51. A protrusion 52 is fitted in the through hole of the axial unit 41. The outer diameter of the disk portion 51 is larger than the outer diameter of the axial unit 41 and slightly smaller than the outer diameter of the bearing sleeve 30. The disk portion 51 is axially arranged in opposed relation to the lower end surface of the bearing sleeve 30. The lower surface opening of the housing 20 is closed by a plate 60 located in opposed relation to the lower side of the cap 50.

The cylindrical portion 42 of the rotor hub 40 covers the outer surface of the housing 20. A mount 42a to mount a recording disk (not shown) on is formed by being projected radially outward on a part of the outer peripheral surface of the cylindrical portion 42. An annular disk 42b extending radially outward is formed integrally on the outer periphery of the mount 42a. An annular rotor magnet 70 is fixed in contact with the mount 42a and the part of the cylindrical portion 42 lower than the mount 42a, and the upper surface of the rotor magnet 70 is covered by the protrusion 42b. The rotor hub 40 and the rotor magnet 70 make up a rotary unit.

The minuscule gap between the axial unit 41 and the bearing sleeve 30, the minuscule gap between the bearing sleeve 30 and the disk portion 51 of the cap 50 and the minuscule gap between the cover 43 and the housing 20 are filled with a lubricating oil incessantly. One or both of the two opposed surfaces forming each of these minuscule gaps are formed with a dynamic pressure groove. Thus, a dynamic pressure is generated in the lubricating oil in these minuscule gaps so that the rotary unit is supported rotatably in both axial and radial directions.

A stator 80 is fittingly fixed on the inner peripheral surface of the annular depression 11 of the base member 10. The stator 80 includes a stator core 82 having a plurality of teeth 81a and a substantially annular core back 81b, and a winding 83 wound on each one of the teeth 81a. The plurality of the teeth 81a are arranged radially inward of the core back 81b. An insulator 90 constituting an insulating member having a plurality of protrusions to hold a crossover of the winding is fixed on the upper surface of the inner periphery of the core back 81b of the stator 80. The inner peripheral surface of the teeth 81a and the rotor magnet 70 are arranged radially in opposed relation to each other through a minuscule gap. In the spindle motor for rotationally driving the recording disk not more than 1 inch, the torque required for rotational drive is small and so only a small amount of magnetic force is required of the rotor magnet 70. As a result, less leakage magnetic fluxes are generated from the rotor magnet 70 and the teeth 81a. As long as the axial gap between the upper surface of the winding 83 of the stator 80 and the upper surface of the mount 42a of the rotor hub 40 is not less than 0.2 mm, therefore, the leakage magnetic fluxes from the rotor magnet 70 and the teeth 81a have no effect on the recording disk and the magnetic head. In the case where the gap between the upper surface of the winding 83 and the upper surface of the mount 42a is not less than 0.2 mm, the magnetic shield plate conventionally required to prevent the leakage of magnetic fluxes is done without. To reduce the thickness of the spindle motor, the axial gap is suitably set to about 0.2 mm to 1.2 mm. A flexible printed circuit board 100 (hereinafter referred to as the FPC 100) arranged in contact with the upper surface of the insulator 90 is fixed by bonding, for example.

By supplying the current to the winding 83 of the stator 80 through the FPC 100 from an external power supply, a magnetic field is generated in the stator 80, and a rotary torque is generated by interaction between the magnetic field and the rotor magnet 70 thereby to rotate the rotary unit.

<Essential Parts>

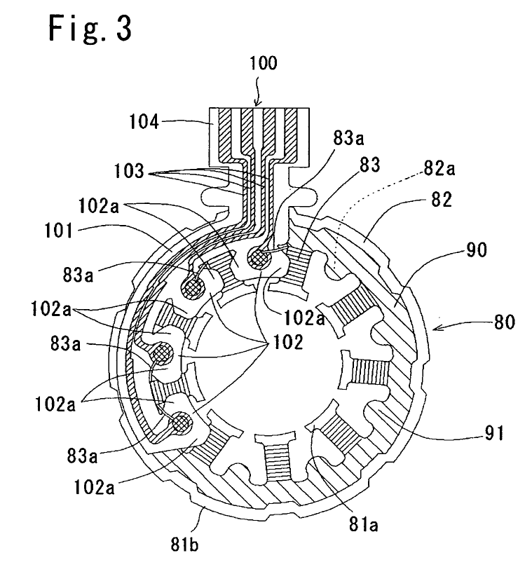

Next, the relative positions of the base member 10, the stator 80, the insulator 90 and the FPC 100 constituting the essential parts of the invention are explained with reference to FIGS. 3 to 5.

First, the manner in which the stator 81 and he insulator 90 are mounted is explained. Protrusions 82a are formed on the inner peripheral edge between each pair of adjacent ones of the teeth 81a of the core back 81b of the stator 80. The protrusions 82a are each formed with a depression having an upper opening. In place of theses depressions, through holes may be formed. The insulator 90 is arranged along the inside of the core back 81b of the stator 80, and a protrusion 91 is formed at a position corresponding to each protrusion 82a of the core back 81b. Further, the protrusion 91 has a protrusion at a position corresponding to each depression of the protrusion 82a. The depression and this protrusion engage each other thereby to fix the insulator 90 on the stator 80.

Next, the FPC 100 is explained with reference to FIG. 3. The FPC 100 includes an arcuate body 101 along the core back 81b of the stator 80. The FPC 100 is mounted on the upper surface of the stator 80 with the body 101 arranged on the core back 81b. In the FPC 100, a plurality of (four, in this case) connecting portions 102 for connecting to the leads 83a from the winding 83 of the stator 80 are formed by being extended radially inward from the body 101 in such a manner as to be arranged between adjacent ones of the teeth 81a. According to this embodiment, the spindle motor driven in three phases has formed therein four connecting portions 102 corresponding to the leads 83a of U phase, V phase, W phase and common phase. A copper foil pattern 103 formed on the FPC 100 connects a land of each connector 102 and each of the terminal portions arranged on the external connector 104 through the body 101. An external power is supplied from the external connector 104 and, through the copper foil pattern 103, the lands and the leads 83a, supplied to the winding 83.

A protruded portion 102a extending peripherally outward is formed on each side of each connector 102 of the FPC 100. Each connector 102 is set-so that the circumferential width including the protrusions 102a on both side thereof is larger than the gap between adjacent ones of the teeth 81a. The protrusions 102a on both sides of each connector 102 are extended under the winding 83 wound on the adjacent teeth 81 into contact with the lower surface or the side surface of the winding 83. This contact portion is fixed by an adhesive or the like thereby to hold each connector 102 of the FPC 100. The lower surface of each connector 102 may alternatively be coated with a pressure sensitive adhesive and bonded to the inner surface of the annular depression 11. The reliability for a longer period of time can be assured, however, by using an adhesive. Also, by fixing the FPC 100, the fixed position thereof can be held against external shocks or the like, and therefore the risk of the winding being moved and broken is avoided. The body 101 can also be fixed by coating a pressure sensitive adhesive on the back thereof, but a long-lasting reliability can be secured suitably by use of an adhesive for fixing.

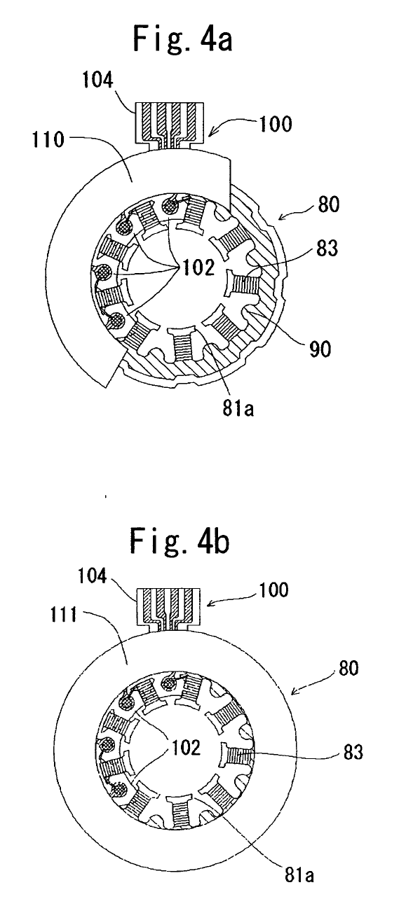

Next, the manner in which the body 101 of the FPC 100 and the insulator 90 are fixed to each other using a seal 110 is explained. As shown in FIG. 4a, a corresponding arcuate film-like seal 110 is arranged on the upper surface of the body 101 of the FPC 100. This seal 110 is fixed in contact with a part of the FPC 100 and the base member 10. In the prior art, a magnetic shield plate of stainless steel having magnetism is arranged to fix the FPC. The magnetic shield plate is conductive, however, and therefore a shorting is liable to occur by contact with the FPC connecting portions. To avoid this problem, an insulating sheet of polyester resin or the like having an insulation ability is conventionally inserted between the magnetic shield plate and the FPC. The axial height around the stator 80 which is the sum of the height of the stator core 82, the winding 83, the magnetic shield plate and the insulating plate, however, is so large as to hamper the thickness reduction of the spindle motor. More specifically, a total of 170 μm including the thickness 100 μm of the magnetic shield plate and the thickness 70 μm of the insulating sheet is extraneously required. With the seal 110 according to the invention, in contrast, the FPC 100 is only fixed and the portions lacking the FPC 100 have substantially no seal 110. As a result, the axial height of the magnetic head can be reduced by the thickness 170 μm of the conventional magnetic shield plate and the insulating polyester, thereby realizing a thinner spindle motor.

Also, the seal 110 and the FPC 100 are fixed to a part of the base member 10 in such a manner that a pressure sensitive adhesive is coated in advance on the reverse surface of the seal 110 and fixed by contact with the FPC 100 and a part of the base member 10. In another conceivable method, an adhesive may be used to improve the reliability. From the viewpoint of workability and price reduction of the spindle motor, however, the pressure sensitive adhesive is a choice. As long as a sufficient contact area can be secured between the seal 110 and the base member 10, the reliability can be improved also with the pressure sensitive adhesive. The FPC 100 is fixed by the seal 110, and therefore the rise of the body 101 of the FPC 100 can be prevented. By setting the axial thickness of the seal 110 to not more than 0.1 mm (not more than 100 μm), the axial size of the stator can be reduced by 70 μm as compared with the prior art. In this way, the thickness of the spindle motor can be reduced.

FIG. 4b shows another example of the seal forming an annular seal 111. The seal 111 in annular form stabilizes the peripheral air flow with the rotation of the rotary unit for an improved rotation accuracy of the rotary unit. In addition, the contamination, etc. which otherwise may leak out of the spindle motor can be prevented thereby improving the reliability of the spindle motor.

The pressure sensitive adhesive is coated over the whole surface of the seals 110, 111 contacting the FPC 100 so that the FPC 100 can be fixed on the seals 110, 111 by contact on the surface coated with the pressure sensitive adhesive. Thus, the FPC 100 is not required to be bonded independently on the stator 80, thereby reducing the bonding step and easily fixing the FPC 100. This process is suitable to secure the workability and the price reduction of the spindle motor. Also, in order to improve reliability, an adhesive may alternatively be coated on the surface of the seals 110, 111 in contact with the FPC 100.

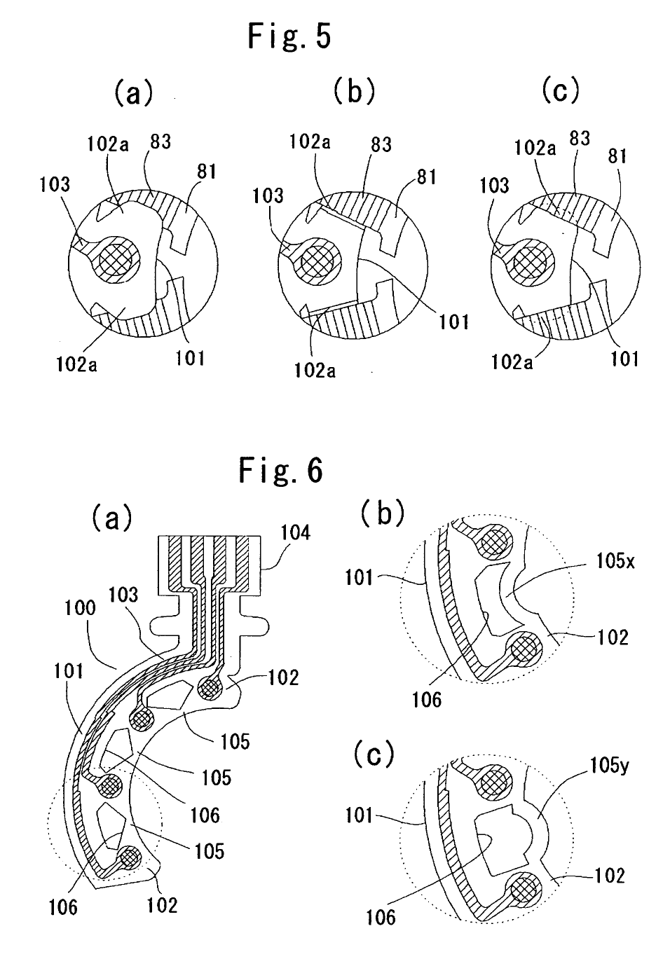

FIG. 5 shows the process of arranging each connector 102 of the FPC 100 under the winding 83 of the stator 80. FIG. 5(a) shows the state of the connector 102 in which the FPC 100 is arranged above the stator 80 and the body 101 is bonded on the stator 80. In this state, the connector 102 is located between adjacent teeth 81a, and the protrusions 102a on both sides thereof are located above the winding 83 of the two teeth 81a. Under this condition, the lead wire 83a from the winding 83 is soldered to the land of the connector 102 to electrically connect the winding 83 to the FPC 100. FIG. 3 shows this state.

Next, each connector 101 of the FPC 100 is pushed in between adjacent teeth 81a and bent downward of the body 101. In the process, as shown in FIG. 5(b), the protrusions 102a on both sides of the connecting portion 102 come into contact with the windings 83 of adjacent teeth 81a, respectively, while at the same time being bent upward by the elasticity of the FPC 100. Pushing the connecting portion 102 further downward, the protrusions 102a of the connecting portion 102 soon come off downward from the winding 83, and as shown in FIG. 5(c), intrude into the space under the winding 83 of the adjacent teeth 81a by the elastic restitutive force thereof. Each protrusion 102a of each connector 102 bend downward of the body 101 comes to engage the winding 83 of the teeth 81a from thereunder and therefore is prevented from rising. Under this condition, the adhesive is applied to the connecting portion 102 between the adjacent teeth 81a and the surrounding. The adhesive flows in and fills up the space between the base member 10 and the connecting portions 102 and between the winding 83 and the protrusions 102a. As a result, the upper surfaces of the protrusions 102a of the connecting portions 102 and the lower surfaces of the winding 83 are fixedly bonded to each other, and so are the lower surfaces of the connecting portions 102 and the base members 10. Since the fixedly bonded area is large, the fixing strength is high. This is suitable for the portable HDD requiring a high shock resistance.

### Other Embodiments

FIG. 6 shows FPCs according to other embodiments. The FPC 100 shown in FIG. 6(a) includes a arcuate body 101 formed along the core back 81b of the stator 80, four connecting portions 102 projected radially inward of the body 101 and an external connector 104. Adjacent ones of the connecting portions 102 are coupled to each other by a coupler 105. This FPC 100 is formed with three teeth insertion holes 106 defined by the body 101, the connecting portions 102 and the couplers 105. The land of each connecting portion 102 is connected to the terminal of the external connector 104 through a copper foil pattern 103.

In the FPC 100 shown in FIG. 6(a), three adjacent ones of the teeth 81a wound with the winding 83 of the stator 80 are inserted into the three teeth insertion holes 106, respectively, from the radially inner ends thereof. After that, the body 101 is placed on the core back 81b of the stator 80 and mounted on the stator 80. The four connecting portions 102 of the FPC 100 are each arranged between adjacent ones of the teeth 81a, and each coupler 105 for coupling the connecting portions 102 is located under the corresponding teeth 81a. In this way, the connecting portions 102 of the FPC 100 are prevented from being raised, and since the coupler 105 engages the teeth 81, the movement in axial direction is restricted against external shocks, etc. In this case, unlike in the first embodiment described above, the process of fixedly bonding the protrusions 102a is eliminated, and the connecting portions 102 can be arranged fixedly by a simple method.

In the FPC 100 described above, each coupler for coupling adjacent ones of the connecting portions 102 is located under the teeth 81, and therefore suitably formed slightly longer than the gap between the adjacent teeth 81. As shown in FIG. 6(b), for example, the coupler 105x for coupling the adjacent connecting portions 102 is not formed with the same radius of curvature as the arc of the body 101 but arcuately with such as a radius of curvature as to be curved radially outward. As an alternative, as shown in FIG. 6(c), the coupler 105y is formed arcuately to be curved radially inward.

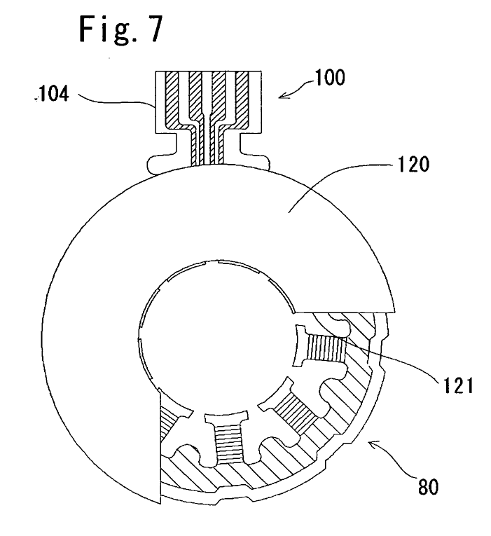

Next, the embodiment shown in FIG. 7 is explained. FIG. 7 shows a state in which a magnetic shield plate 120 is mounted on the upper surface of the stator 80 of the spindle motor. An annular magnetic shield plate 120 having a notch at a position corresponding to the area where the magnetic head 5a of the head moving mechanism 5 moves is mounted along the stator core 82 on the upper surface of the stator 80 shown in FIG. 4a, when the magnetic shield plate is monted annually. This magnetic shield plate 120 is molded in arcuate form of stainless steel having magnetism by plasticization. As described above, the FPC 100 is arranged on the upper surface of the stator core 82, and after the FPC 100 is thus prevented by the insulating sheet 110 from being raised, the magnetic shield plate 120 is mounted on the stator 80. In view of the fact that the magnetic shield plate 120 has a notched portion corresponding to the movable range of the magnetic head 5a, the magnetic head 5a can be arranged axially downward as compared with a magnetic head plate lacking such a notched portion and arranged on the stator. As described above, the total thickness of the insulating sheet and the magnetic shield plate is about 170 μm, and therefore the spindle motor having a correspondingly thickness about 170 μm can be implemented.

The spindle motors according to the embodiments of the invention are explained above. This invention is not limited to these embodiments, but various modifications are possible.

A fluid dynamic bearing, for example, is employed for the spindle motor according to the embodiments of the invention. Instead, a ball bearing can be used for the same purpose.

Also, the shape of the FPC 100 is not limited to the protrusions 102a and the couplers 105, 105x, 105y of the connecting portions 102 included in the embodiments of the invention. Instead, a portion in axially superposed contact relation with a part of the winding 83 of the teeth 81a can be secured to hold the connecting portions 102 under the teeth 81a of the stator 80.

Further, the embodiments described above represent the spindle motor of what is called axial rotation type as an example making up a rotary member with the shaft 41 fixed on the rotor hub 40. Nevertheless, this invention is also applicable to a spindle motor of what is called axial fixed type with the shaft making up a part of the stationary members.

What is claimed is:

1. A spindle motor of inner rotor type comprising:
a stator including a stator core fixed on a base which has an annular core back and a plurality of teeth projected radially inward from the core back, and a coil wound on each of the teeth;
a flexible printed circuit board including a land connected with an end of the coil to lead the land electrically outward; and
a rotary unit rotatably supported on the base and including a rotor magnet arranged in opposed relation to the inner peripheral end surface of each of the teeth;
wherein the flexible printed circuit board includes an outer frame located on the upper surface of the core back of the stator core and a plurality of connecting portions formed continuously in radial direction inward of the outer frame with the land located between adjacent ones of the teeth, and the connecting portions are arranged under the stator in the form bent down from the outer frame.

2. A spindle motor according to claim 1,
wherein the outer frame of the flexible printed circuit board is substantially arcuate and arranged along the core back.

3. A spindle motor according to claim 1,
wherein the plurality of the connecting portions of the flexible printed circuit board are branched individually from the outer frame, the circumferential width of each of the connecting portions is larger than the gap between the coils of adjacent ones of the teeth, and the circumferential ends of each of the connecting portions is arranged under the adjacent teeth.

4. A spindle motor according to claim 3,
wherein each of the connecting portions is fixed on the base by selected one of a pressure sensitive adhesive and an adhesive.

5. A spindle motor according to claim 1,
wherein the plurality of the connecting portions of the flexible printed circuit board are interconnected with the forward end portions of adjacent ones thereof coupled by a coupler, and adjacent ones of the connecting portions include the outer frame and the coupler for coupling the adjacent connecting portions, the connecting portions being formed with the teeth and insertion holes through which the coil wound on the teeth is inserted.

6. A spindle motor according to claim 1,
wherein an insulator having protrusions for engaging a crossover of the winding between adjacent teeth is arranged on the upper surface of the core back of the stator core, and the flexible printed circuit board is mounted on the upper surface of the insulator.

7. A spindle motor according to claim 1,
wherein the base is formed with a depression having a circular outer periphery, the stator core is fittingly fixed on the inner peripheral wall surface of the depression, and an arcuate or circular insulating sheet is mounted over the upper surface of the base outside the depression and the flexible printed circuit board on the stator core.

8. A spindle motor according to claim 1,
wherein a magnetic shield plate is mounted on the upper surface of the stator at least to cover a part of the upper surface of the stator to shield the leakage magnetic fluxes from the stator.

9. A spindle motor according to claim 1,
wherein the rotary unit is arranged integrally with a magnetic shield wall covering the axially upper side of the rotor magnet.

10. A spindle motor according to claim 1,
wherein the rotary unit is rotatably supported on the base by a dynamic bearing.

11. A recording disk drive using a circular recording disk, comprising:
a housing for accommodating the recording disk;
a spindle motor arranged on the bottom of the housing to rotate while holding the disk; and
a head moving mechanism having a magnetic head for reading and writing information in the recording disk;
wherein the spindle motor includes
a stator fixed on a base and having a stator core which has an annular core back and a plurality of teeth projected radially inward from the core back, and a coil wound on each of the teeth,
a flexible printed circuit board having a land connected with an end of the coil to lead the land electrically outward, and
a rotary unit rotatably supported on the base and including a rotor magnet arranged in opposed relation to the inner peripheral end surface of each of the teeth,
wherein the rotary unit is formed with a mounting surface on which the recording disk is mounted and held, the recording disk being integrally rotated with the rotary unit, and
wherein the flexible printed circuit-board includes an outer frame located on the upper surface of the core back of the stator-core and a plurality of connecting portions formed continuously in radial direction inward from the outer frame with each of the lands arranged under between adjacent ones of the teeth, the connecting portions being arranged under the stator in the form bent down from the outer frame.

12. A recording disk drive according to claim 11,
wherein the axial gap between the upper surface of the stator and the mounting surface of the rotary unit is set to not less than 0.2 mm.
